(19) United States
(12) Patent Application Publication
(10) Pub. No.: US 2020/0055520 A1
(43) Pub. Date: Feb. 20, 2020

(54) METHOD FOR CARRYING OUT COLD-STARTING

(71) Applicant: ZF Friedrichshafen AG, Friedrichshafen (DE)

(72) Inventors: Rico GLÖCKNER, Pocking (DE); Jan-Frederik KUHN, Friedrichshafen (DE); Marcus HIEMER, Meckenbeuren (DE); Robert MORRISON, Tettnang (DE); Andreas WEBER, Immenstaad (DE)

(21) Appl. No.: 16/344,474

(22) PCT Filed: Sep. 19, 2017
(86) PCT No.: PCT/EP2017/073655

§ 371 Date: Apr. 24, 2019

(30) Foreign Application Priority Data
Oct. 26, 2016 (DE) 10 2016 221 126.9

(51) Int. Cl. B60W 30/194; B60W 10/103; B60W 10/02; B60W 10/06

(52) U.S. Cl. CPC B60W 30/194; B60W 10/103; B60W 10/02; B60W 2710/0644; B60W 2710/021; B60W 2710/1072; B60W 2710/1077; B60W 10/06

(57) ABSTRACT

A method for performing a cold start in a vehicle having a power-spat transmission with a hydrostatic element comprising hydrostatic units. Several cold-start steps are performed sequentially for a cold start, the length of at least one of the cold-start steps is adapted depending on a temperature representing the start temperature of the power-split transmission. A state of the power-split transmission deviating from the temperature of the power-split transmission is monitored, during the execution of at least one of the cold-start steps, and, depending on this state, a transition from the respective cold-start steps to the subsequent cold-start step is performed, thus adapting the length of time of the respective cold-start steps.

This application is a National Stage completion of PCT/EP2017/073655 filed Sep. 19, 2017, which claims priority from German patent application serial no. 10 2016 221 126.9 filed Oct. 26, 2016.

### FIELD OF THE INVENTION

The invention relates to a method for performing a cold start in a vehicle, which has a power-split transmission having a hydrostatic element comprising hydrostatic units.

### BACKGROUND OF THE INVENTION

The basic structure of a vehicle having a power-split transmission, which has a hydrostatic element comprising hydrostatic units, is known to persons skilled in the art. For instance, DE 10 2007 047 194 A1 discloses the structure of a drive train of such a motor vehicle. The drive unit or an engine is coupled to an input shaft of the power-split transmission. The power-split transmission has a hydrostatic branch and a mechanical branch, which are combined using a summation gear designed as a planetary gear. The power-split transmission provides at least two driving ranges in a forward direction of travel and at least two driving ranges in a reverse direction of travel. To this end, the power-split transmission comprises a clutch for forward drive and a clutch for reverse drive, wherein the clutch for the forward drive and the clutch for the reverse drive are also referred to as reversing clutches. The driving ranges in the forward and reverse directions are provided via speed clutches, also referred to as range clutches. The hydrostatic branch of the power-split transmission comprises a hydrostatic element. Such a hydrostatic element is provided by a first hydrostatic unit and a second hydrostatic unit, wherein one of the hydrostatic units functions as a pump and the other hydrostatic unit functions as a motor.

From DE 10 2009 045 510 further details of a hydrostatic element are known, wherein this hydrostatic element also comprises two hydrostatic units. The hydrostatic units of the hydrostatic element interact with a position control valve. The position control valve can be used to apply a hydraulic pressure to the hydrostatic units of the hydrostatic to actuate the latter.

In DE 2009 045 510 A1, a high-pressure control valve furthermore interacts with the position control valve. However, a hydrostatic element, which does not require such a high-pressure control valve but just has a position control valve, is also known.

From practice, it is also known to install pressure sensors in the area of the hydrostatic element. Typically, two pressure sensors are installed in a hydrostatic system, wherein, amongst others, the hydrostatic units of the hydrostatic element are pressurized and regulated as a function of the measured values of these pressure sensors.

Hydrostatic power-split transmissions have the disadvantage that, unlike converter transmissions, insufficient heat energy is generated in the transmission to sufficiently heat the hydraulic fluid in the power-split transmission.

From DE 10 2015 200 682 A1, a method for performing a cold start in a vehicle having a power-split transmission comprising a hydrostatic element is known. There, several cold-start steps are completed, wherein the order and the length of the cold-start steps depend on the start temperature of the hydraulic fluid at the beginning of the cold start and are altered. Even though the method known from DE 10 2015 200 682 A1 provides an effective method for a cold start of a vehicle having a power-split transmission, which comprises a hydrostatic element, the cold start of such a vehicle needs to be improved further.

From DE 10 2010 007 987 A1 a method for a cold start of a motor vehicle comprising an automatic transmission is known.

### SUMMARY OF THE INVENTION

On this basis, the invention addresses the problem of providing a novel method for performing a cold start in a vehicle having a power-split transmission having a hydrostatic element.

This object is achieved by a method according to the independent claim(s).

In accordance with the invention, during the execution of at least one cold-start step, one state of the power-split transmission deviating from the temperature of the power-split transmission is monitored, wherein a transition is made from that cold-start step to a subsequent cold-start step depending on respective states, thus adapting the length of time of the respective cold-start steps.

In the method according to the invention for performing a cold start of a vehicle having a power-split transmission, which has a hydrostatic element, when performing at least one cold-start step, one state of the power-split transmission, which differs from the temperature of the latter, is monitored preferably by means of an in-transmission sensor. Depending on that state, i.e. depending on whether [certain] conditions are met in a cold-start step, there is a change from the current cold-start step to a subsequent cold-start step, thereby adapting the length of time of the individual cold-start step, by monitoring the state deviating from the temperature of the power-split transmission state. As a result, the cold start of a vehicle having a power-split transmission can be performed within a shorter period of time.

The method according to the invention has further advantages in addition to the short period of time, in which the cold start according to the invention can be performed. For instance, the method according to the invention for performing a cold start is robust with respect to the existing boundary conditions, such that in particular no adaptation of the method with respect to different degrees of coldness of the power-split transmission, with respect to different viscosities of the hydraulic oil, and with respect to structural changes in the transmission has to be made. Thus, regardless of the period of time during which the power-split transmission has cooled down, regardless of whether the power-split transmission uses a winter oil or a summer oil, and regardless of the specific design of the transmission, the method can be used to perform a cold start within a short period of time and thus with little loss of comfort.

According to an advantageous development of the invention, the following cold-start steps are performed successively for a cold start: First, a pressurization step to pressurize the power-split transmission and to heat the latter by operating a transmission pump. Subsequently, a pressure-gauge step to assess the pressurization of the transmission. Then, a first heating step to engage at least one reversing clutch in the power-split transmission and to heat the former using the power losses incurred in the power-split transmission. Subsequently, a pulsation step to engage and disengage the range clutches of the power-split transmission in a pulsed manner therein. Subsequently, a second heating step to heat at least one position control valve of the hydrostatic element in the power-split transmission. Subsequently, a drive-off preparation step to check a behavior of the reversing clutches and the hydrostatic element of the power-split transmission and to prepare the power-split transmission for the vehicle driving off. Due to the sequential cycling of these cold-start steps, the cold start can be performed very effectively within a short period of time. The function of the power-split transmission is continuously monitored during at least some of the above cold-start steps. Based on this assessment, the duration of the respective cold-start steps is determined at least for some cold-start steps of the cold-start process.

Preferably, during the pressurization step, a first partial pressurization step, in which a drive unit is operated at a relatively low drive unit speed, leads to a second partial pressurization step, in which the drive unit operates at a relatively high engine speed, wherein the transition from the first partial pressurization step to the second partial pressurization step depends on at least two pressures in the hydrostatic element.

Preferably, the shift from pressurization step to pressure-gauge step depends on a minimum period of the pressurization step, This makes for a particularly advantageous transition from the pressurization step to the pressure-gauge step.

The shift from the pressure-gauge step to the first heating step preferably depends on at least two pressures in the hydrostatic element. This makes for a particularly advantageous transition from the pressure-gauge step to the first heating step.

The shift from the first heating step to the pulsation step preferably depends on a comparison of an actual behavior of the hydrostatic element with a defined actuation of the latter and a corresponding target behavior of the hydrostatic element. This makes for a particularly advantageous transition from the first heating step to the pulsation step.

Preferably, the transition from the pulsation step to the second heating step depends on a definite number of pulsations, which is selected at the beginning of the cold start depending on the temperature representing the start temperature of the power-split transmission. This makes for a particularly advantageous transition from the pulsation step to the second heating step.

Preferably, the transition from the second heating step to the drive preparation step depends on a defined time period, which is independent of the temperature representing the start temperature of the power-split transmission. This makes for an advantageous transition from the second heating step to the drive preparation step.

Preferably, the drive preparation step and thus the cold start are terminated as a function of a reduction of the differential rotational speed, which develops during an engagement process of the reversing clutches, and as a function of a reaction time resulting from the actuation of the hydrostatic element. This makes for a particularly advantageous termination of the drive preparation step and thus the actual cold start.

### BRIEF DESCRIPTION OF THE DRAWINGS

Preferred developments are presented in the subclaims and the description below. Exemplary embodiments of the invention will be described with reference to the drawings, without being limited thereto. In the figures:

FIG. 1 shows a signal flow diagram illustrating the sequence of cold-start steps of the method according to the invention for performing a cold start in a vehicle having a power-split transmission, which has hydrostatic units;

FIG. 2 shows a time diagram to illustrate details of a pressurization step of the method according to the invention;

FIG. 3 shows a time diagram to illustrate further details of a pressurization step of the method according to the invention;

FIG. 4 shows a time diagram to illustrate details of a pressure-gauge step of the method according to the invention;

FIG. 5 shows a time diagram to illustrate details of a first heating step of the method according to the invention;

FIG. 6 shows a time diagram to illustrate further details of the first heating step of the method according to the invention;

FIG. 7 shows a time diagram to illustrate details of a pulsation step of the method according to the invention;

FIG. 8 shows a time diagram to illustrate details of a second heating step of the method according to the invention;

FIG. 9 shows a time diagram to illustrate details of the drive-off preparation step of the method according to the invention;

FIG. 10 shows a time diagram to illustrate further details of the drive-off preparation step of the method according to the invention;

FIG. 11 shows a time diagram to illustrate further details of the drive-off preparation step of the method according to the invention; and

FIG. 12 shows a block diagram of a vehicle having a power-split transmission, which has a hydrostatic element.

### DETAILED DESCRIPTION OF THE PREFERRED EMBODIMENTS

The invention relates to a method for performing a cold start in a vehicle, which has a power-split transmission comprising a hydrostatic element.

For such a vehicle, a drive unit is coupled to an input shaft of the power-split transmission.

The power-split transmission comprises a mechanical branch in addition to a hydrostatic branch into which the hydrostatic element is integrated. The mechanical branch and the hydrostatic branch are combined and split, respectively. The power-split transmission can provide at least two driving ranges and thus speeds each for both one forward and one reverse direction, wherein the power-split transmission has reversing clutches and range clutches for that purpose. The hydrostatic element, which is also referred to as hydrostatic element, can be controlled using a position control valve of the former, Pressure sensors can be used to monitor the pressure in the hydrostatic element, which comprises two hydrostatic units acting as pump and motor.

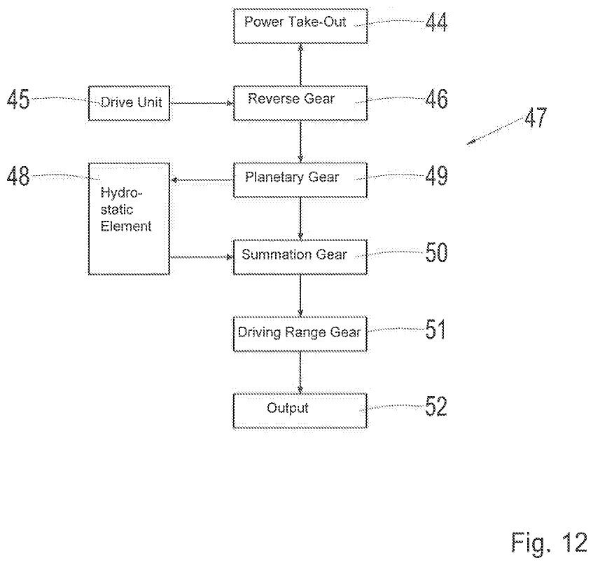

FIG. 12 shows an exemplary block diagram of a vehicle having a drive unit 45, a power take-out 44, an output 52 and a power-split transmission 47 having a so-called secondary clutch in a schematic view. The power-split transmission 47 includes a hydrostatic element 48, which interacts with a planetary gear 49 and a summation gear 50, wherein the summation gear 50 has gear stages, The hydrostatic element 48 comprises the hydrostatic units acting as pump and motor. On the drive side, a reverse gear 46 is connected between the planetary gear 49 and the drive unit 45 and the power take-off 44, which reverse gear has the reversing clutches for shifting between the forward direction and the reverse direction of travel. On the output side, a driving range gear 51 having the range clutches is connected between the summation gear 50 and the output 52 for providing the at least two driving ranges. Within every driving range, in the forward direction of travel and in the reverse direction of travel, drive power can be continuously provided at the output 52. The power-split transmission 47 comprises the hydrostatic element 48, the planetary gear 49, the summation gear 50, the reverse gear 46 and the driving range gear 51. The actual power split occurs in the hydrostatic element 48, the planetary gear 49 and the summation gear 50.

This basic setup is familiar to the person skilled in the art and is known in particular from DE 10 2007 047 194 A1 and from DE 10 2009 045 510 A1.

To perform a cold start on such a motor vehicle, several cold-start steps are performed in succession. The length of at least one of the cold-start steps depends on a temperature representing the start temperature of the power-split transmission, such as the start temperature of the hydraulic oil of the power-split transmission.

The start temperature is preferably a temperature measured at the time of engine start or ignition, for instance, the pertinent temperature of the hydraulic oil in the power-split transmission.

According to the invention, during the execution of at least one cold-start step, one state of the power-split transmission deviating from the temperature of the power-split transmission, in particular the temperature of the hydraulic oil, is monitored. Depending on this state, a transition from the individual cold-start step, in which the state deviating from the temperature of the power-split transmission is monitored, is then made to the subsequent cold-start step, wherein the length of time of the relevant cold-start step, in which the state deviating from the temperature of the power-split transmission is monitored, will be adapted.

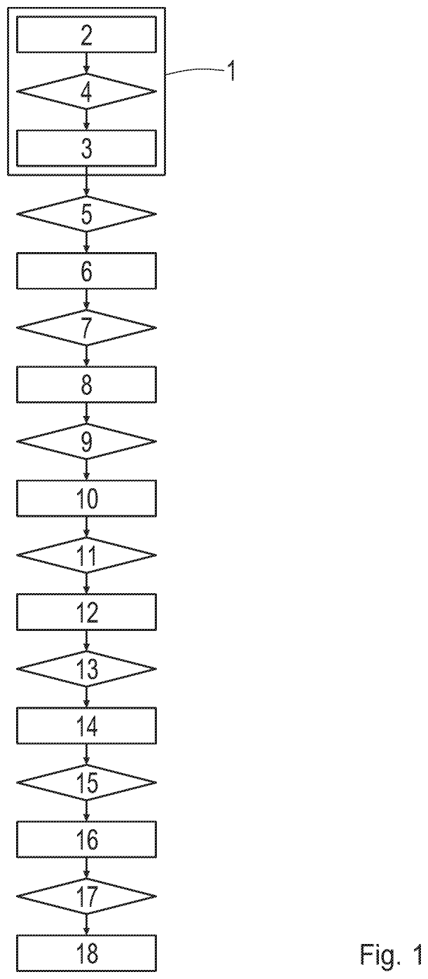

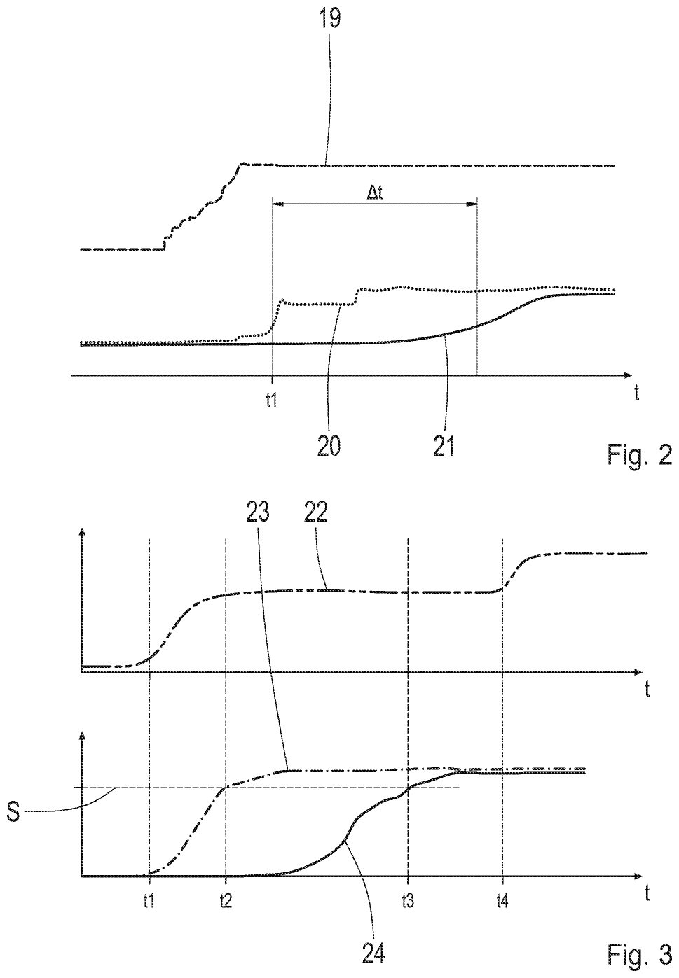

The method according to the invention for performing a cold start is described in detail below with reference to FIGS. 1 to 11, wherein FIG. 1 shows a signal flow diagram representing the sequence of the individual cold-start steps, and FIGS. 2 to 11 show details of different cold-start steps of the method.

In the cold start according to the invention, first a pressurization step 1 is performed to pressurize the power-split transmission in a defined manner, and to heat the power-split transmission using the operation of a transmission pump thereof. In the pressurization step 1, the power-split transmission is heated solely by the gear pump of the former.

According to FIG. 1, the pressurization step 1 is subdivided into a first partial pressurization step 2 and a second partial pressurization step 3. In the first partial pressurization step 2, the drive unit of the vehicle is operated at a relatively low drive unit speed, whereas in the second partial pressurization step 3, the drive unit of the vehicle is operated at a relatively high drive unit speed. The speed of the gear pump depends thereon.

Accordingly, in the first partial pressurization step 2, the rotational speed of the drive unit and thus of the gear pump is lower than that in the second partial pressurization step 3.

In block 4 of the signal flow diagram of FIG. 1, a transition condition 4 for the transition from the first partial pressurization step 2 to the second partial pressurization step 3 is assessed for fulfillment, wherein this transition from the first partial pressurization step 2 to the second partial pressurization step 3 depends on at least two pressures in the hydrostatic element. As mentioned above, two pressure sensors are installed in the hydrostatic element. When the pressure readings provided by the pressure sensors, i.e. the pressure readings of both pressure sensors, reach or exceed a certain threshold or limit value, the second partial pressurization step 3 of the pressurization step 1 is activated, starting from the first partial pressurization step 2 of the pressurization step 1, and the drive unit speed increases accordingly.

There, provision is made in particular for a minimum dwell time or minimum period of the first partial pressurization step 2, such that the transition from the first partial pressurization step 2 to the second partial pressurization step 3 is only made when the minimum period of the first partial pressurization step 2 has been reached and both pressure sensors also provide measured values that are above a defined threshold or limit.

During the pressurization step 1, an assessment is made as to whether a minimum dwell time or minimum period has been achieved for the second partial pressurization step 3 as well. In that case and if the corresponding transition condition 5 is fulfilled, starting from the pressurization step 1, that is, from the second partial pressurization step 3, transition is made to a pressure-gauge step 6.

It should be noted at this point that the minimum dwell times or minimum periods of the first partial pressurization step 2 and of the second partial pressurization step 3 can depend on the start temperature of the power-split transmission or on the start temperature of the hydraulic oil.

The lower the start temperature, the longer the corresponding minimum dwell times to be selected.

In FIG. 2 a time diagram is used to illustrate further details of the first partial pressurization step 2 of the pressurization step 1 as a function of time t, wherein FIG. 2 shows three curves 19, 20 and 21 as a function of time t, to be exact the time profile 19 as a speed curve of the drive unit and the hydrostatic drive measurements provided by the two sensors as curves 20 and 21. When, at time t1 of the first partial pressurization step 2 of FIG. 2, the drive unit speed 19 has reached a defined level corresponding to the relatively low speed of the first partial pressurization step 2, subsequently the two hydrostatic pressure sensors provide the measurement signals 20, 21, wherein a time offset Δt between the measurement signals 20, 21 provided by the pressure sensors is brought about by the fact that the pressure sensor providing the measurement signal 20 is undamped, i.e. has no hydraulic aperture, whereas the pressure sensor providing the measurement signal 21 is damped and has a hydraulic aperture.

The viscosity of the hydraulic oil, in particular whether there is high-viscosity or low-viscosity hydraulic oil, can be inferred from the time offset Δt.

The time profiles of FIG. 3 show further details of the pressurization phase 1, wherein the signal curve 22 in FIG. 3 is yet another lime profile of the drive unit speed as a function of time t, and wherein the curves 23 and 24 in turn visualize the hydrostatic readings provided by the two pressure sensors.

Accordingly, the pressure sensor providing the measuring signal 23 is again an undamped pressure sensor without a hydraulic aperture and the pressure sensor providing the measuring signal 24 is a damped pressure sensor having a hydraulic aperture.

In FIG. 3, the pressurization phase 1 starts at time t1, namely the first partial pressurization phase 2, for which purpose the drive unit speed 22 is raised to a defined speed level between the times t1 and t2, and subsequently remains constant between the times t2 and t3 of FIG. 3, The first partial pressurization phase 2 thus occurs between the times t1 and t3.

At the time t3, the measured values 23 and 24 of both pressure sensors reach a threshold value S, such that a transition from the first partial pressurization step 2 to the second partial pressurization step 3 and an increase of the drive unit speed can generally occur starting at the time t3, wherein in FIG. 3 the shift from the first partial pressurization step 2 to the second partial pressurization step 3 occurs only at the time t4 while increasing the drive unit speed 22, as a function of a minimum dwell time or minimum period of the first partial pressurization phase 2, to protect the gear pump.

Thus the first partial pressurization phase 2 of the pressurization phase 1 extends from the time t1 to the time t4 in FIG. 3. At the time t4, the change from the first partial pressurization phase 2 to the second partial pressurization phase 3 occurs with the drive unit speed 22 being increased. When a corresponding minimum period or minimum dwell time has been reached for the second partial pressurization phase 3, then according to this transition condition 5 of the block 5 of FIG. 1 the transition from the pressurization step 1 to the pressure-gauge step 6 is performed.

In the pressure-gauge step 6, the measured value provided by the two pressure sensors of the hydrostatic element is assessed. In particular, an assessment is made as to whether the measured value of both pressure sensors is above a defined threshold value or limit value. In that case, i.e. if the relevant transition condition 7 of the block 7 of FIG. 1 is fulfilled, the transition from the pressure-gauge step 6 to a first heating step 8 is performed.

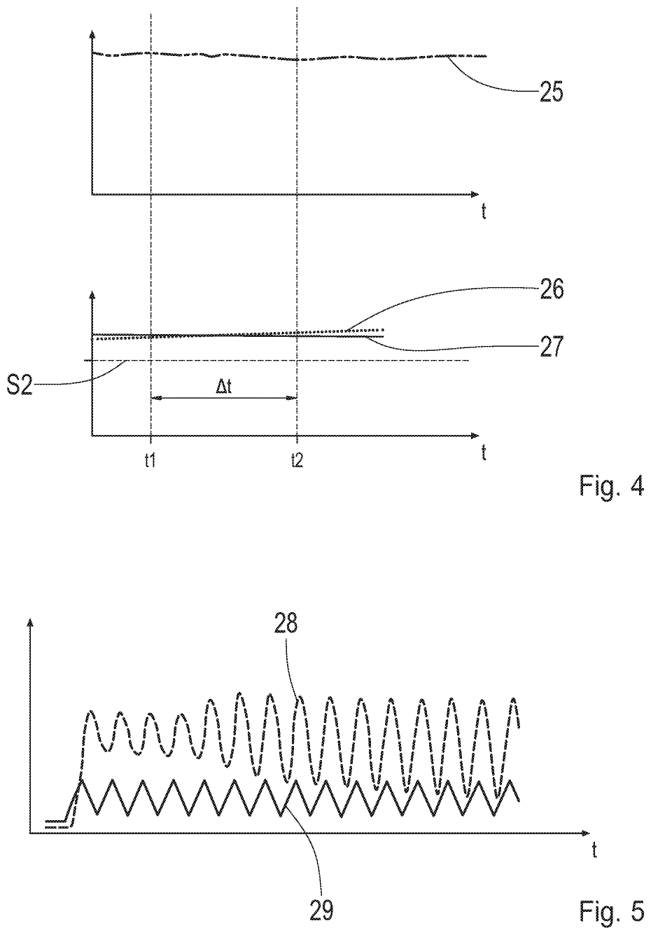

Details of the pressure-gauge step 6 are shown in the time diagram of FIG. 4, wherein FIG. 4 shows a drive unit speed over time t as the first signal curve 25 and the curves 26 and 27 again show measured values of the pressure sensors. The pressure-gauge step 6 starts at the time t1 in FIG. 4, wherein at the time t1 the measured values 26, 27 of both pressure sensors of the hydrostatic element are greater than a pertinent threshold value or limit value S2. That time t1 does not coincide with the time t1 of FIGS. 2 and 3. In every cold-start step, the respective times always relate only to the respective cold-start steps. In the pressure control phase, the measurement signal 26, 27 of the two pressure sensors must be permanently above the threshold value S2 of the pressure-gauge step 6 for a defined period of time Δt, which is limited by the times t1 and t2 in FIG. 4, such that at time t2 in FIG. 4, the transition condition 7 is fulfilled and the transition from the pressure-gauge step 6 to the first heating step 8 can be made.

In the first heating step 8, a reversing clutch of the power-split transmission is engaged for the first time, namely either the clutch for the reverse drive or the clutch for the forward drive. As a result of this engagement of the relevant reversing clutch, a force flow to the planetary gear or to the superposition gear and thus to the hydrostatic element is established, generating power dissipation for heating the power-split transmission in the first heating step using the generated power dissipation. While the relevant reversing clutch is engaged during the first heating phase 8, the position control valve is used to apply an initially small and later larger current amplitude to the hydrostatic element, This actuation moves the hydrostatic element between a certain angle and a specific ratio.

In the first heating step 8, therefore, the hydrostatic element is actuated in a defined manner and in doing so, an actual behavior of the hydrostatic element is determined. The defined actuation denotes the application of an alternating current amplitude to the latter, and the reaction or in the actual behavior denotes the ratio, which can be determined using speed sensors mounted at the hydrostatic element,

When the actual behavior corresponds to a predetermined target behavior or deviates from the target behavior by no more than a defined limit value, the transition condition 9 is fulfilled and then the transition from a pulsation step 10 to the first heating step 8 is made. During the first heating step 8, the drive unit speed can be changed, preferably increased.

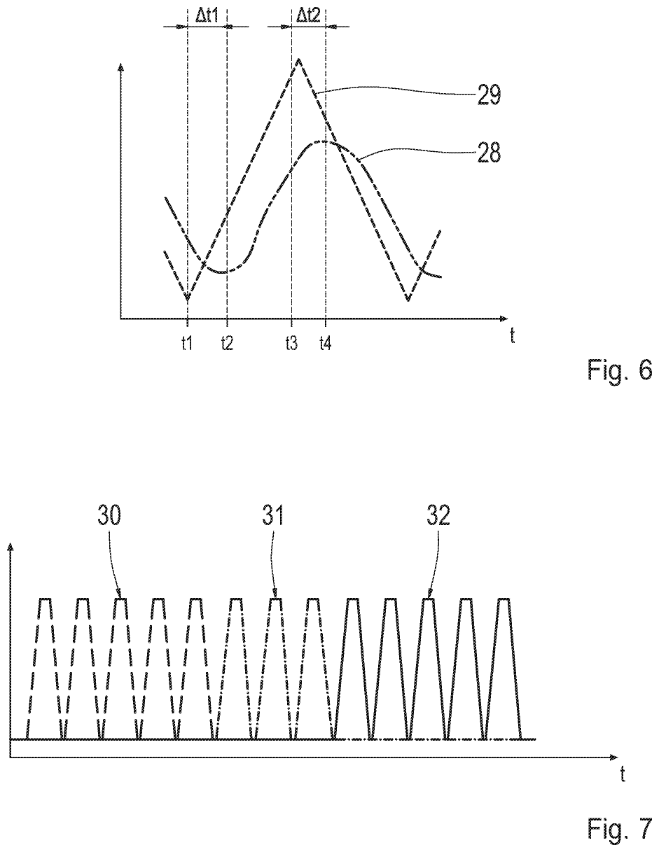

FIGS. 5 and 6 show details of the first heating phase 8. FIG. 5 shows two signal curves 28 and 29 over time t, wherein the signal curve 29 visualizes the actuation of the hydrostatic element based on an alternating current amplitude, and the signal curve 28 shows the ratio of the hydrostatic element as it develops. The actuating current 29 is used to actuate the position control valve of the hydrostats.

FIG. 6 shows further details of the first heating phase 8, wherein FIG. 6 shows a section of the signal curves 28 and 29 over the time t, wherein the signal curve 29 corresponds to the energization of the position control valve of the hydrostatic element, and wherein the signal curve 28 shows the ratio of the hydrostatic element developing as a result of this energization of the position control valve.

At the time t1, the energization of the position control valve of the hydrostatic element reaches a minimum. Subsequently, at the time t2, the ratio of the hydrostatic element reaches a corresponding minimum. The time offset Δt1, which is determined by these two times t1 and t2, corresponds to a first parameter of the actual behavior of the hydrostatic element as a result of the defined actuation of the position control valve.

At the time t3 in FIG. 6, the energization or the actuation current of the position control valve of the hydrostatic element reaches a maximum, at the subsequent time t4 the developing ratio 28 of the hydrostatic reaches a corresponding maximum, wherein the time period Δt2 between the times t3 and t4 describes the actual behavior of the hydrostatic element.

When it is determined that the actual time offsets correspond to respective target time offsets, or do not deviate from them by more than a threshold value of these time offsets Δt1 and Δt2, the transition condition 9 is fulfilled and the transition from the first heating step 8 to the pulsation step 10 is made.

In the pulsation step 10, range clutches of the power-split transmission are alternately engaged and disengaged, i.e. pulsed. The pulsing of the range clutch of the power-split transmission is conducted based on a fixed number. When the fixed number of pulses for engaging and disengaging the range clutches of the power-split transmission is reached, the transition condition 11 is fulfilled, and the transition from the pulsation step 10 to a second heating step 12 is made.

FIG. 7 shows actuation currents 30, 31 and 32 for three range clutches of the power-split transmission in a time diagram as a function of time t. The number of pulses of the actuating current for engaging and disengaging the range clutches is determined at the beginning of the cold start depending on the start temperature of the power-split transmission or the temperature representing the start temperature of the power-split transmission. This can be done depending on a characteristic map or a characteristic curve. When each of the range clutches of the power-split transmission has been engaged and disengaged in a defined manner in the pulsation step 10 using the corresponding number of energization pulses, the transition condition 11 is fulfilled, and the transition from the pulsation step 10 to the second heating step 12 is made. The pulsing is performed to actuate the range clutches of the power-split transmission during the cold start to extract hydraulic oil from the feed lines to the ranges clutches and from the range clutches as such.

In the second heating, step 12 of the cold start, the position control valve of the hydrostatic element is warmed up and overshot, in accordance with a fixed time scheme. The length of time of the second heating step is identical for all temperature ranges, i.e. independent of the start temperature of the power-split transmission or of the temperature representing or corresponding to the start temperature of the latter.

The second heating step 12 is used to overstretch the position control valve of the hydrostatic element in its two end positions using a suitable magnet and thus to flush any existing, highly viscous oil out of the position control valve. The second heating step 12 ensures that the adjustment system of the hydrostatic element, which consists of adjustment cylinder, adjustment valve, adjustment magnet and feedback system was fully actuated and thus no undesirable behavior is to be expected in the end positions of the former.

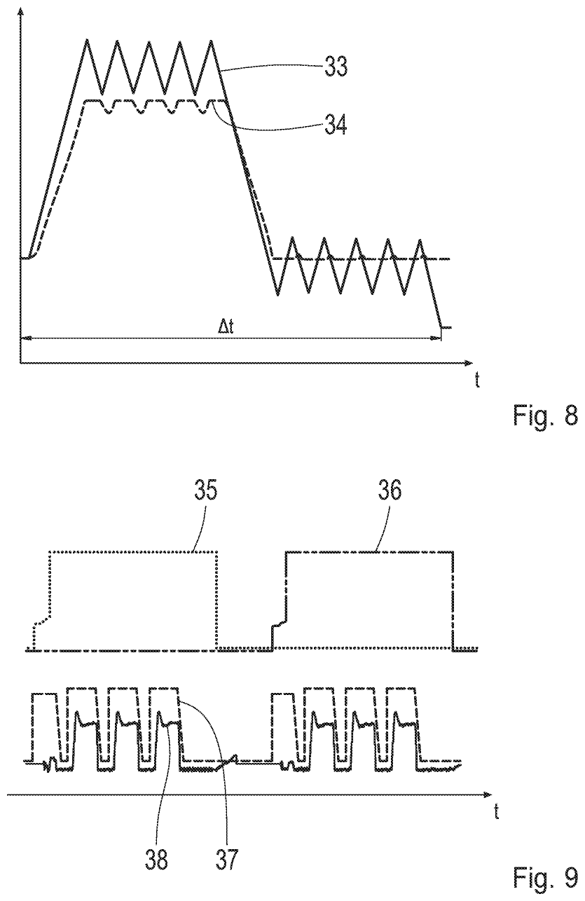

FIG. 8 specifies further details of the second heating step 12, wherein the time profiles 33 and 34 are shown over time t in FIG. 8, i.e. the curve 33 showing an energization of the position control valve of the hydrostatic element and the curve 34 showing the reaction developing, i.e. a ratio of the hydrostatic element. During the second heating step 12, which is performed for a predetermined period of time Δt, the total adjustment system is therefore transferred to its end positions in order to actuate the latter along the whole of its adjustment path.

The transition from the second heating step 12 to a drive-off preparation step 14 is made when a transition condition 13 is fulfilled, depending on a defined period of time, which is independent of the start temperature of the power-split transmission or the temperature representing the start temperature of the power-split transmission.

The transition condition 13 for the transition from the second heating step 12 to the drive preparation step 14 is therefore the temperature-independent, defined time period of the second heating step, and the transition from the second heating step 12 to the drive preparation step 14 is made once the time period of the second heating step has elapsed.

A behavior of the reversing clutches and the hydrostatic element of the power-split transmission is assessed in the drive preparation step 14, and the power-split transmission is prepared for a subsequent drive-off operation of the vehicle.

When a defined differential speed reduction develops during the engagement of the reversing clutches, and when depending on an actuation of the hydrostatic element, a defined reaction time has developed at the former, the drive preparation step, and thus the actual cold start, is terminated if the pertinent transition condition 15 is fulfilled, to thus make the transition from the drive preparation step 14 to a wait state or a standby state for a drive-off request, wherein this standby state is visualized by the block 16 in FIG. 1.

Details of the drive preparation step 14 will be described below with reference to FIGS. 9 to 11. FIG. 9 shows a plurality of time profiles as plots over time t, where the curve 35 shows the actuation of a first reversing clutch and the curve 36 the actuation of a second reversing clutch. The time profile 37 visualizes an energization of the position control valve of the hydrostatic element and the curve 38 a reaction of the hydrostatic element thereof, namely a ratio developing. The behavior of the reversing clutches and of the hydrostatic element is assessed during the drive preparation step 14. The reversing clutches are engaged based on a defined engagement ramp. If a secondary rotational speed developing at the reversing clutch actuated to engage based on the engagement ramp, is detected, the reversing clutch is engaged in a defined manner. During this engagement process, a period of time is recorded and evaluated for the length of time the individual reversing clutch takes until a differential speed at the reversing clutch has been reduced to zero. The engagement ramp for engaging the individual reversing clutch is selected such that there can be no overfilling and thus no damage to the individual reversing clutch. When the differential speed has been reduced accordingly and the time required is within a specified time limit, the individual reversing clutch is detected as correct. The reversing clutches are applied alternatingly, i.e. engaged reciprocally, until both reversing clutches show a desired time behavior during the differential speed reduction and are thus working properly.

The primary and the secondary rotational speed of the reversing clutch, i.e. the difference between the primary and the secondary rotational speed, are important for the evaluation of a reversing clutch.

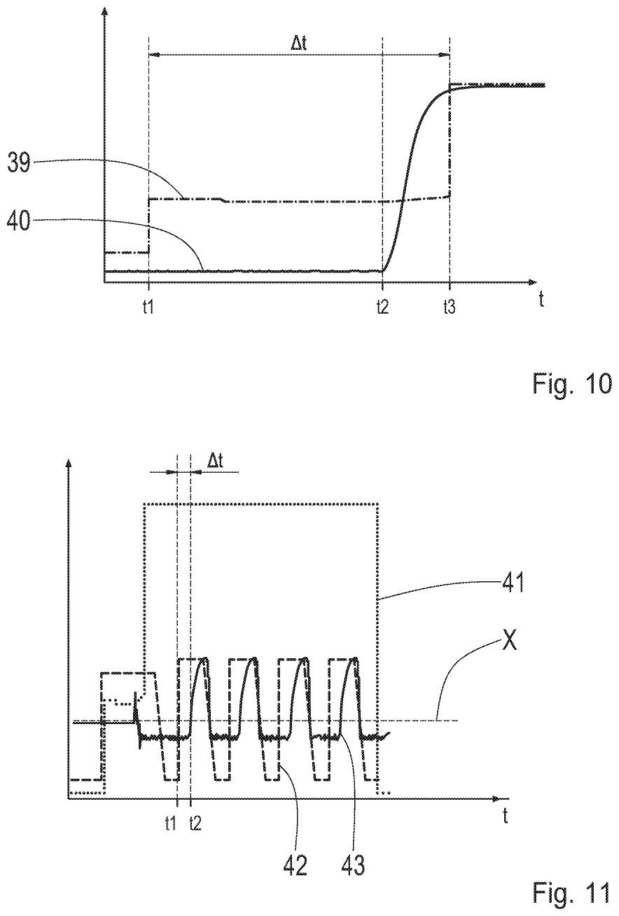

FIG. 10 illustrates the assessment of a reversing clutch during the drive preparation step 14 based on a time diagram over time t. The signal curve 39 visualizes the energization of the individual reversing clutch and the signal curve 40 a reaction developing, i.e. a rotational speed at the respective reversing clutch. At the time t1 in FIG. 10, the engagement operation of the relevant reversing clutch starts, wherein at the time t2 a defined secondary speed is detected at the reversing clutch. At the time t2, the corresponding reversing clutch is then further selectively engaged, wherein at the time t3, the differential speed at the reversing clutch has been reduced to zero in a defined manner. The time period At between the times t1 and t3 of FIG. 10 corresponds to a period of time required after the start of the actuation of the latter at the time t1 to reduce the differential speed at the latter in a defined manner. This time difference Δt is used to evaluate whether the individual reversing clutch works properly and thus shows a desired behavior.

As stated above, in the drive preparation step 14, not only the behavior of the reversing clutches is assessed, but also the behavior of the hydrostatic element, to be exact, as soon as the relevant reversing clutch is engaged and there is a complete flow of power to the hydrostatic dement. As soon as the respective reversing clutch is engaged, the hydrostatic element is actuated by energizing the position control valve of the latter in a defined manner. For that purpose, the energization is increased from an idle current, which is slightly higher than a so-called diagnostic current, to a current slightly higher than a so-called zero-angle current, the zero-angle current being derived from a calibration of the hydrostatic element. In doing so, the length of a time offset or a time lag between the activation of the hydrostatic element and the reaction thereof is evaluated. The evaluation is performed similar to a step response.

This process is repeated or performed several times using a reversible clutch. If the time offset between the activation and the response of the hydrostatic dement is within a defined range of values, the hydrostatic element is evaluated and recognized as functioning properly.

FIG. 11 again shows, over time t, a plurality of time profiles, which visualize the diagnosis of the hydrostatic element during the drive-off preparation step 14. Thus, one curve 41 shows an engaged state of a reversing clutch, which is completely engaged during the assessment of the hydrostatic element. One curve 42 visualizes the energization of the position control valve of the hydrostatic and a curve 43, the reaction forming as a result of this energization, namely a forming translation. As soon as it has become known that the energization of the position control valve has been lowered to a defined value according to the curve 42 after a proper reversing clutch and engaged reversing clutch have been detected, the energization of the position control valve is suddenly increased to a defined value at the time t1, and an assessment is made as to when in accordance with the curve 43, as a reaction of the hydrostatic element, the ratio thereof is above a defined value X. This time offset Δt, which is defined by the times t1 and t2, i.e. the time offset after which the current supply of the position control valve has jumped up and in response to which the ratio of the hydrostatic element has changed above the value x, is detected and evaluated. If this time offset Δt is within a defined value range, then the hydrostatic element is recognized as functioning properly.

When both the reversing clutches and the hydrostatic element are detected to be properly operating in the drive preparation step 14, the transient condition 15 is fulfilled, and the transition is made from the drive preparation step 14 to the wait state 16 or to the drive-off standby state 16.

During the wait state 16, i.e. after completion of the cold start, the system waits for a drive-off request by the driver. In doing so, an engine control unit specifies the drive unit speed instead of a transmission control unit controlling the cold-start process. During the wait state 16, the fulfillment of a transition condition 17 is therefore assessed, which transition condition is a request for a drive-off process, wherein if that transition condition is fulfilled, transition is made to the drive-off state 18 of FIG. 1 and a drive-off process is performed.

If, during the waiting state 16, the driver does not request a drive-off process for a defined period of time, at least one reversing clutch can be engaged in a defined manner during the waiting state to generate power dissipation in the power-split transmission and thus avoid re-cooling of the power-split transmission.

The event-based cold start method according to the invention can be used to perform a cold start of a vehicle having a power-split transmission comprising a hydrostatic element within a short time and extremely robustly. The reversible clutches and the hydrostatic element can be checked for their proper functionalities.

The method for performing a cold start according to the invention in a vehicle provides a kind of field diagnosis for the transmission which can be used to monitor the proper operation of the transmission in the field. All the steps or phases of the process are run through, warranting the safe operation of the transmission. Upon completion of the process, a vehicle having a transmission with increased or full dynamics and with reduced or no loss of comfort is available. The method is robust and therefore not prone to failure in case of an unsuccessful start of the drive unit at low temperatures, a cold restart of the drive unit and viscosity of the gear oil used.

### REFERENCE NUMERALS

1 pressurization step

2 partial pressurization step

3 partial pressurization step

4 transition condition

5 transition condition

6 pressure-gauge step

7 transition condition

8 first heating step

9 transition condition

10 pulsation step

11 transition condition

12 second heating step

13 transition condition

14 preparatory drive step

15 transition condition

16 wait state

17 transition condition

18 drive-off state

19 time profile

20 time profile

21 time profile

22 time profile

23 time profile

24 time profile

25 time profile

26 time profile

27 time profile

28 time profile

29 time profile

30 time profile

31 time profile

32 time profile

33 time profile

34 time profile

35 time profile

36 time profile

37 time profile

38 time profile

39 time profile

40 time profile

41 time profile

42 time profile

43 time profile

44 Power-Take-Out

45 drive unit

46 reversing gear

47 power-split transmission

48 hydrostatic element

49 planetary gear set

50 summation gear

51 driving range gear

52 output

1-10. (canceled)

11. A method of performing a cold start in a vehicle having a power-split transmission having a hydrostatic element comprising hydrostatic units, the method comprising:
performing several cold-start steps sequentially for a cold start;
adapting a length of at least one of the cold-start steps depending on a temperature representing a start temperature of the power-split transmission;
monitoring at least one value of an in-transmission sensor of the power-split transmission during execution of at least one of the cold-start steps; and
performing a transition from the respective cold-start steps to the subsequent cold-start step depending on the at least one value, thus adapting the length of time of the respective cold-start steps.

12. The method according to claim 11, further comprising, for the cold start, successively performing the cold-start steps listed below:
first, performing a pressurization step to pressurize the power-split transmission and to heat the power-split transmission by operating a transmission pump;
subsequently, performing a pressure-gauge step to check the pressurization of the power-split transmission;
then, performing a first heating step to engage at least one reversing clutch in the power-split transmission and to heat the at least one reversing clutch using power losses incurred in the power-split transmission;
subsequently, performing a pulsation step to engage and disengage range clutches of the power-split transmission in a pulsed manner;
subsequently, performing a second heating step to heat at least one position control valve of the hydrostatic element in the power-split transmission; and
subsequently, performing a drive-off preparation step to check a behavior of the reversing clutches and the hydrostatic element of the power-split transmission and to prepare the power-split transmission for a vehicle driving off.

13. The method according to claim 12, further comprising transitioning, during the pressurization step, from a first partial pressurization step, in which a drive unit is operated at a relatively low drive unit speed, to a second partial pressurization step, in which the drive unit is operated at a relatively high drive unit speed.

14. The method according to claim 13, further comprising transitioning from the first partial pressurization step to the second partial pressurization step depending on at least two pressures in the hydrostatic element.

15. The method according to claim 12, further comprising transitioning from the pressurization step to the pressure-gauge step depending on a minimum length of time of the pressurization step.

16. The method according to claim 12, further comprising transitioning from the pressure-gauge step to the first heating step depending on at least two pressures in the hydrostatic element.

17. The method according to claim 12, further comprising transitioning from the first heating step to the pulsation step depending on a comparison of an actual behavior of the hydrostatic element reacting to a defined actuation thereof and a corresponding target behavior of the hydrostatic element.

18. The method according to claim 12, further comprising transitioning from the pulsation step to the second heating step depending on a definite number of pulsations, which is selected at a beginning of the cold start depending on the temperature representing the start temperature of the power-split transmission.

19. The method according to claim 12, further comprising transitioning from the second heating step to the drive-off preparation step depending on a defined period of time, which is independent of the temperature representing the start temperature of the power-split transmission.

20. The method according to claim 12, further comprising terminating the drive-off preparation step, and thus the cold start, depending on a reduction of differential speed at the reversing clutches during an engagement operation of the reversing clutches and depending on a reaction time developing upon actuation of the hydrostatic element.
